(19) United States
(12) Patent Application Publication
(10) Pub. No.: US 2014/0085230 A1
(43) Pub. Date: Mar. 27, 2014

(54) INFORMATION PROCESSING DEVICE, INPUT DEVICE, AND INFORMATION PROCESSING METHOD

(71) Applicant: KABUSHIKI KAISHA TOSHIBA, Tokyo (JP)

(72) Inventors: Yuki SATO, Tokyo (JP); Yuji NAKAJIMA, Tokyo (JP)

(73) Assignee: Kabushiki Kaisha Toshiba, Tokyo (JP)

(21) Appl. No.: 13/888,260

(22) Filed: May 6, 2013

(30) Foreign Application Priority Data
Sep. 26, 2012 (JP) 2012-213083

(51) Int. Cl. G06F 3/041

(52) U.S. Cl. CPC G06F 3/0416
USPC 345/173

(57) ABSTRACT

According to one embodiment, an information processing device includes: a display; a first detector configured to detect displacement of a first area of the display when the display is bent; a second detector configured to detect displacement of a second area of the display when the display is bent; and a controller configured to direct performance of a first operation based on the displacement of the first area and the second area.

### CROSS-REFERENCE TO RELATED APPLICATIONS

This application is based upon and claims the benefit of priority from Japanese Patent Application No. 2012-213083, filed Sep. 26, 2012; the entire contents of which are incorporated herein by reference.

### FIELD

Embodiments described herein relate generally to an information processing device, an input device, and an information processing method relating to an input system using a flexible display.

### BACKGROUND

Flexible displays (for example, plastic organic electroluminescent (EL) displays) are novel devices that are so thin and flexible that they can be bent and rolled. In recent years, sheet-like tablets, electronic books, or what is called electronic paper that use the devices have been developed. Among their functionalities, desired is an input of control signals with bending (for example, page turning with bending). However, there arises a problem that a touch panel can malfunction because of interaction of parts of the touch panel while being bent. Thus, it is difficult to realize both bending and touch mechanisms. Accordingly, desired are a specific structural design for bending detection and a system that uses a curvature of the bending to prevent malfunction of a touch panel.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram illustrating a display input system according to an embodiment;

FIG. 2 is an exemplary mounting configuration view illustrating a part of components (units) in the embodiment;

FIG. 3 is an exemplary view for explaining a strain gauge sensor in the embodiment;

FIG. 4 is an exemplary table illustrating correspondence examples between bending and control input in the embodiment;

FIG. 5 is an exemplary cross-sectional plan view schematically illustrating the mechanism of detection to be used in the embodiment;

FIGS. 6A and 6B are exemplary diagrams of a sheet display comprising a capacitive touch sensor in the embodiment and of the mechanism of malfunction due to bending;

FIG. 7 is an exemplary flowchart illustrating processing of turning touch sensor detection off (preventing malfunction) with curvature detection to be used in the embodiment;

FIGS. 8A and 8B are exemplary diagrams illustrating expansion of a detection amount to be used in the embodiment;

FIG. 9 is an exemplary diagram illustrating expansion of the detection amount to be used in the embodiment;

FIGS. 10A to 10C are exemplary diagrams for explaining an example of a detection accuracy improvement mechanism using a Hall element in one embodiment;

FIG. 11 is an exemplary diagram for explaining an example of a device to improve detection accuracy in one embodiment; and

FIGS. 12A and 12B are exemplary diagrams for explaining an example of an application of a touch panel cancel mechanism for a narrow frame model in one embodiment.

### DETAILED DESCRIPTION

In general, according to one embodiment, An information processing device comprises: a display; a first detector configured to detect displacement of a first area of the display when the display is bent; a second detector configured to detect displacement of a second area of the display when the display is bent; and a controller configured to direct performance of a first operation based on the displacement of the first area and the second area.

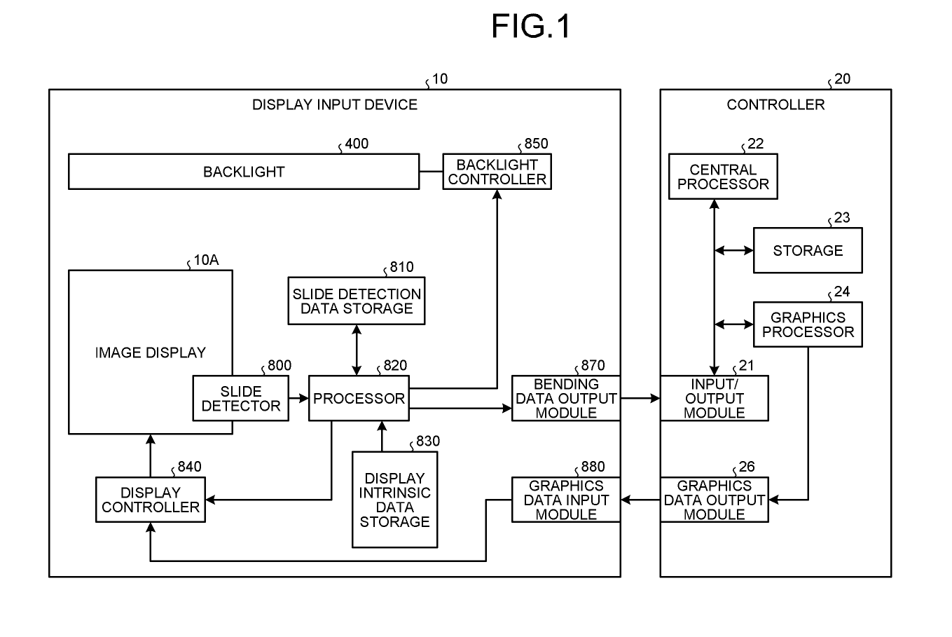

Hereinafter, an embodiment of the invention is described with reference to FIG. 1 to FIG. 12B.

FIG. 1 is a block diagram illustrating a display input system according to the embodiment.

A display input device 10 comprises an image display 10A, a slide detector 800, a slide detection data storage 810, an processor 820, a display intrinsic data storage 830, and a display controller 840. Data acquired by the slide detector 800 is processed by the processor 820 and is output as bending data. In this process, for example, data previously acquired and stored in the slide detection data storage 810, slide detection data in a flat state, and data from the display intrinsic data storage 830 storing therein data intrinsic to the display, such as the size and definition of the display, are also output to the processor 820 and referred.

The bending data obtained by the processor 820 is output to, for example, a backlight controller 850, the display controller 840, and a bending data output module 870. The bending data output from the bending data output module 870 is sent to a controller 20. The controller 20 converts the bending data to digital or analog input data, based on which, for example, processing on software is proceeded and display contents are scrolled, enlarged, and contracted.

Furthermore, the embodiment may correct deterioration in display quality due to bending applied to the display input device 10. For example, when cells of liquid crystal or the like are bent, a desired value for a viewing angle changes in some cases. In addition, a cell gap locally changes in some cases, which can lead to deterioration in display quality. To address this, the bending data output from the processor 820 can be also output to the backlight controller 850 and the display controller 840 so as to correct driving conditions of a backlight 400 and of the cells of the liquid crystal or the like.

In this manner, when feedback in response to a bending direction and a bending amount requires relatively simple processing, the backlight controller 850 and the display controller 840 make correction. Furthermore, when a bending stress beyond a bending limit is exerted on the display input device 10, for example, feedback may be made to the backlight controller 850 so as to flash or turn off the backlight 400 in order to warn a user. Feedback to the display controller 840 may include displaying a warning dialogue and a specified pattern and flashing on a display screen.

When image display requires complicated correction in response to the bending direction and the bending amount, for example, when an enlargement ratio or a contraction ratio is changed between positions on the display or when applications require different kinds of processing, the bending data may, after being sent to the controller 20 through the bending data output module 870, be processed through an input/output module 21 by a central processor 22, a storage 23, and a graphics processor 24 of the controller 20. Then, display data may be sent through a graphics data output module 26 to a graphics data input module 880 of the display input device 10 in the same manner as the case of normal display processing.

Primary constituent components in the embodiment are a thin, bendable sheet display 10A (D), a touch panel (film, part of the slide detector 800) that detects touch input by the user, strain gauge sensors S mounted on the periphery of the sheet display D, and a system (20) that controls input and prevents malfunction based on the curvature of each of the strain gauge sensors S.

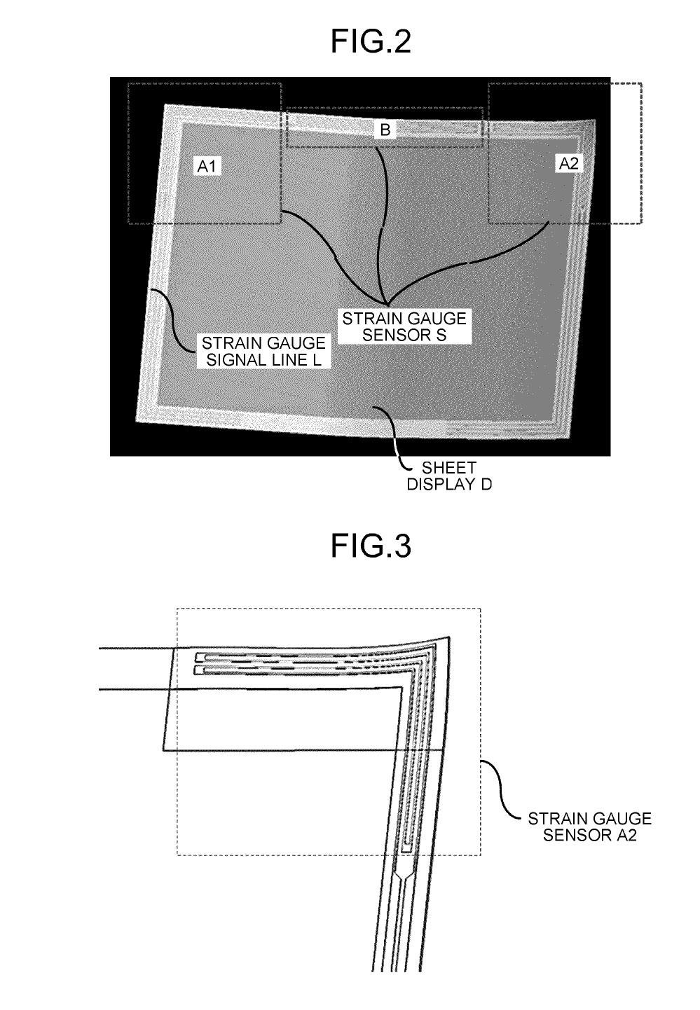

FIG. 2 and FIG. 3 illustrate a part of the components. The embodiment is provided with the sheet display D and the strain gauge sensors (or strain sensors, strain gauges) S as primary components.

FIG. 2 illustrates the sheet display D, which is a flexible, bendable display such as a plastic organic EL display. FIG. 3 illustrates a strain gauge sensor (example of A2 among the sensors S, and signal lines L), which detects bending of the sheet display D as a strain amount. The strain gauge sensor is either attached to the sheet display D or formed directly on the sheet display D through vapor deposition or the like. The strain gauge sensor A2 is composed of conductors such as metals and is provided with three fine bends to enhance resistance (Using two lines of conductors bent to reciprocate increases the number of lines thus arranged so that a change in the resistance can be detected for the number of lines (in this example, four)). A strain gauge sensor A1 is formed symmetric to the strain gauge sensor A2.

FIG. 2 illustrates three strain gauge signal lines L formed at each of the right and left sides on a frame surrounding the sheet display D. The outer two of the strain gauge signal lines L receive signals indicating a change in the resistance value in the A1 and the A2 areas of the strain gauge sensors S. The inner two of the strain gauge signal lines L receive signals indicating a change in the resistance value in a B area of the strain gauge sensors S.

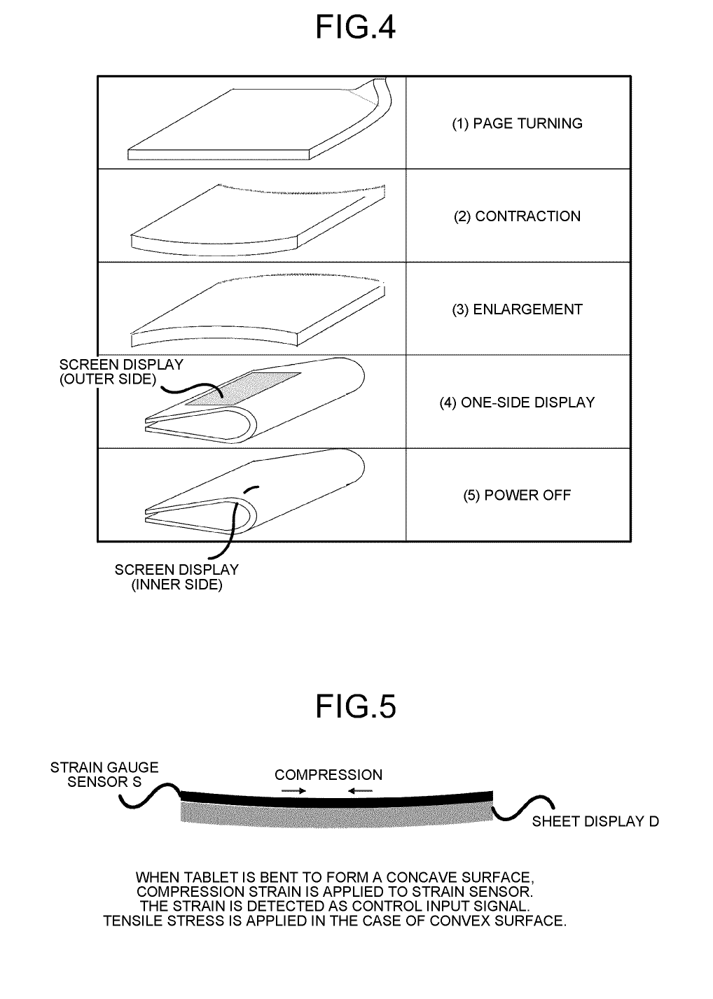

FIG. 4 illustrates basic operations of control input by bending.

(1) Page turning by bending a corner of the tablet. For example, the corner is bent to turn a page while the user is browsing an electronic book and the corner is bent in the opposite direction to turn back the page.

(2) Contraction by bending the tablet overall into a concave shape. For example, the tablet is bent inward to contract a map such as an electronic map.

(3) Enlargement by bending the tablet overall into a convex shape. For example, the tablet is bent outward to enlarge a photograph or the like.

(4) One-side display by folding the tablet in half such that the screen of the tablet faces outward. In a tight space on a crowded train or the like, information is displayed only on a half of the screen by folding the tablet in half. Distinction from (3) can be made by a difference in acceleration or by cancelling an operation not supposed to function when the curvature is stable.

(5) Power-off by folding the tablet in half such that the screen of the tablet faces inward. The tablet is folded in half to be turned off. Distinction from (2) can be made by a difference in acceleration or by cancelling an operation not supposed to function when the curvature is stable.

In order to fabricate the bending input illustrated in FIG. 4, the strain gauge sensors are arranged at at least three places as illustrated in FIG. 2. For example, the strain gauge sensor A2 (or A1) is used for the input (1). The strain gauge sensor B is used for the inputs (2) to (5).

Each of the strain gauge sensors computes a bending direction and a bending amount from compression strain and tensile strain caused by bending, thereby outputting a control signal. For example, in the case of the input (2), processing of increasing a contraction speed can be performed when the bending amount (strain amount) is large, or processing of increasing a contraction speed can be performed based on the speed or acceleration of the bending by acquiring a primary or secondary temporal differential of the resistance change, respectively.

FIG. 5 is a cross-sectional plan view schematically illustrating the mechanism of detection to be used in the embodiment. If a tablet is bent to form a concave surface, compression strain is applied to the strain gauge sensors S on the sheet display D. The strain gauge sensors S detect the strain and output a control input signal. In contrast, if the tablet is bent to form a convex surface, a tensile stress is applied thereto.

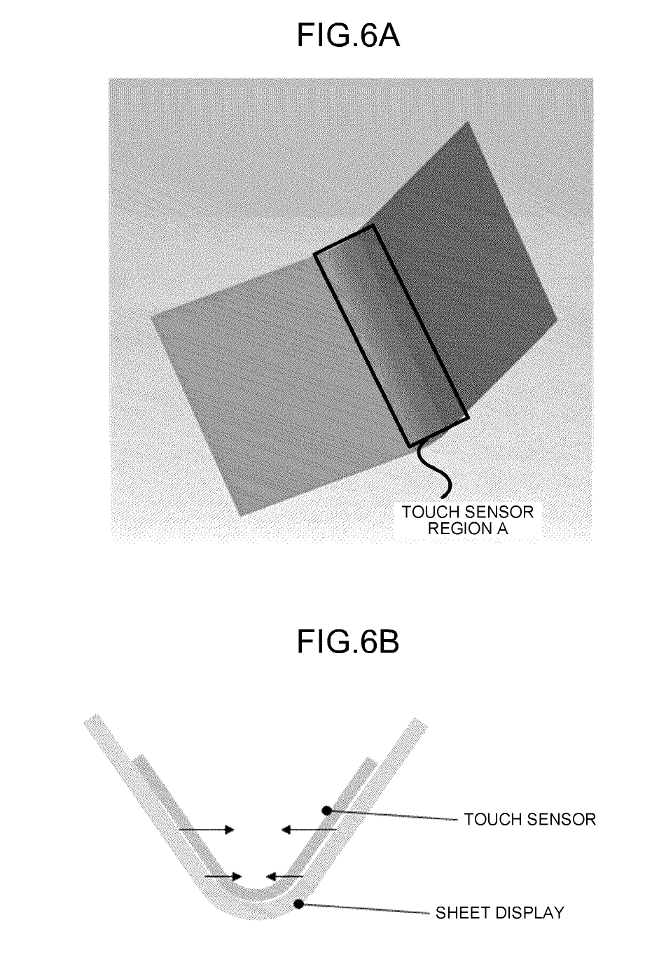

FIG. 6A illustrates a sheet display comprising a capacitive touch sensor and FIG. 6B illustrates the mechanism of malfunction due to bending. As illustrated in FIG. 6A, the sheet display is mounted with the capacitive touch sensor. For example, when the sheet display is folded so as to make parts of the folded surface thereof close to each other, a capacitance is generated in a touch sensor region A to cause the sensor to malfunction. Thus, a twofold tablet or the like is very likely to malfunction when folded as illustrated in FIG. 6B.

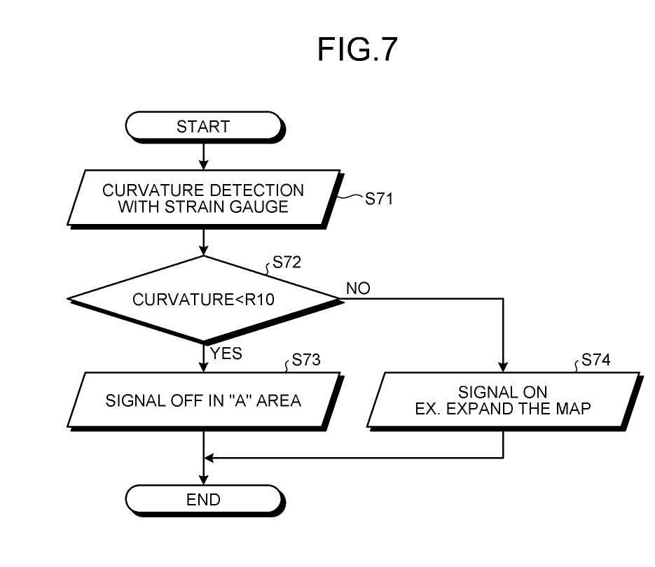

A sheet display comprising touch sensors arranged in a right area and a left area and strain gauge sensors installed at middle points between the right and left touch sensor areas (that is to say, no touch sensor is provided on the folded portion), eliminates the need for prevention of malfunction by turning touch sensor detection off as illustrated in FIG. 7, which will be described next. However, the prevention of malfunction by turning the touch sensor detection off would be effective when the right end of the right area and the left end of the left area come close.

FIG. 7 is a flowchart illustrating processing of turning the touch sensor detection off (prevention of malfunction) with the use of curvature detection. The embodiment provides a mechanism of detecting, with the strain gauge sensors, a curvature that generates electrostatic coupling and of turning off or cancelling the touch sensors in the area where electrostatic coupling is generated.

To be more specific, the mechanism is as illustrated in the flowchart FIG. 7. For example, when electrostatic coupling occurs at a curvature of 10 mm and the curvature is measured (S71) to be lower than 10 mm (R10) (Yes at S72), the touch sensor is turned off or cancelled only in the coupling region (region A in FIG. 6A) (S73). Because the touch sensor is turned off or cancelled only in the region A, a touch operation can be performed on the other regions. If the curvature is equal to or higher than 10 mm (No at S72), the input is processed as a normal input such as an input of enlargement of a map (S74).

In this manner, the touch panel can be partially turned on and off or cancelled by the strain gauge sensor B so as to prevent malfunction.

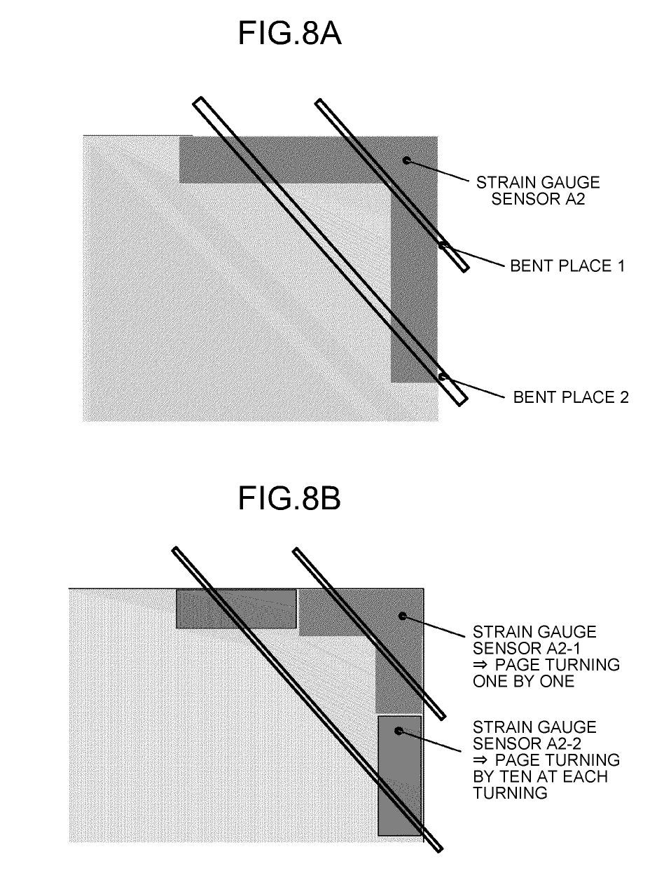

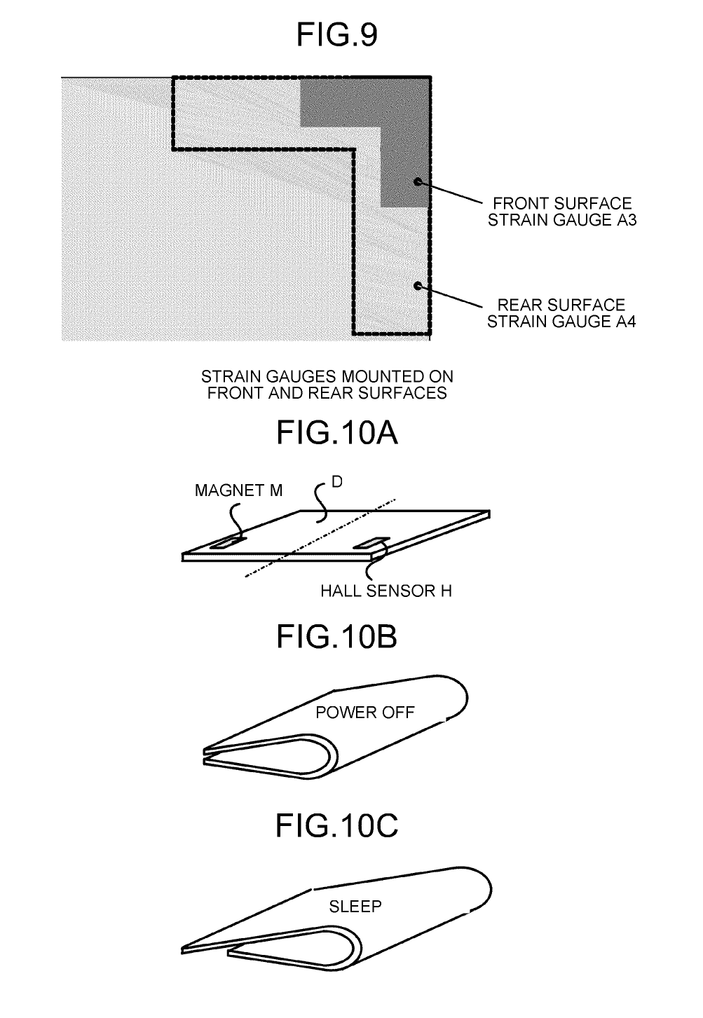

Next, other embodiments and modifications are described. FIGS. 8A, 8B, and 9 illustrate a structure for improving a dynamic range of a bending amount detection range.

An amount and a range detected by one strain gauge sensor are limited. For example, it is difficult to detect a difference between signals obtained by bending a front end portion and an inner portion as illustrated in FIG. 8A. Accordingly, an input signal has been determined only based on the bending amount and the bending speed.

In the embodiment, a new mechanism is added to detect an input signal of a bent place, in addition to the bending amount and the bending speed, by using the structure as illustrated in FIG. 8A. To be more specific, two types of strain gauges are used. A strain gauge sensor A2-1 detects an input signal at the front end portion and a strain gauge sensor A2-2 detects an input signal in the inner portion. For example, as for the page turning, when the end (region where the strain gauge sensor A2-1 covers) is slightly bent, pages are turned one by one. When the inner side (region where the strain gauge sensor A2-2 covers) is bent, pages are turned by ten at each turning. Finer control can be made by associating the bending amount with the bent place.

Furthermore, as illustrated in FIG. 9, the mechanism can be also provided by bonding two strain gauge sensors to front and rear surfaces (A3 is bonded to the front surface and A4 is bonded to the rear surface).

FIGS. 10A to 10C are diagrams for explaining an example of a detection accuracy improvement mechanism by using a Hall element for detecting a magnetic field (magnetic flux). FIG. 10A illustrates a mechanism that accurately detects a powered-off or sleep state when the tablet is folded inward in the case where the tablet is folded in half as illustrated in FIG. 4. The mechanism is composed of a combination of a magnet M and a Hall sensor H and can detect whether the two come close to each other.

This mechanism enables detailed settings such as turning off when the tablet is folded with the ends overlapped on each other as illustrated in FIG. 10B and setting the tablet into a sleep state when the ends are not overlapped on each other (when folded in a deviated manner) as illustrated in FIG. 10C. Moreover, the magnet can hold the tablet folded so as to improve portability.

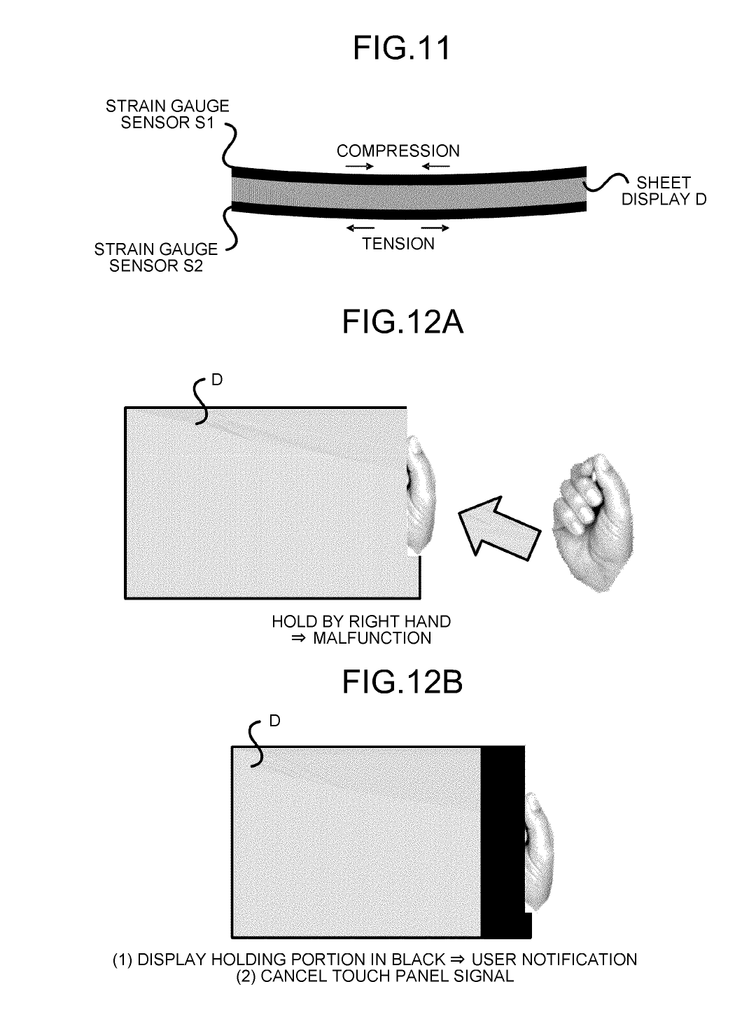

FIG. 11 is a diagram for explaining an example of a device to improve detection accuracy. The strain gauges are arranged on the front and rear surfaces to effectively detect tension and compression. Accordingly, even if a poorly sensitive (low-costing) strain gauge sensor is used for the detection of compression, sufficient effects can be obtained. This is preferable for applications, such as one illustrated in FIG. 4(1), in which the detection frequency at the detection of compression is expected to be high.

FIGS. 12A and 12B are diagrams for illustrating an example of an application of a touch panel cancel mechanism to a narrow frame model. With a thin frame, there is a possibility that a user grasps the screen by mistake when holding the tablet. In order to solve the problem, provided is a method of detecting by a touch sensor that a user has grasped the screen, cancelling an operation, and displaying a cancelled portion in black so as to notify the user of a sensor-off state visually. Specifically, an advanced variation is provided with a touch sensor on the rear surface. The mechanism operates when the touch sensors on the front and rear surfaces are simultaneously touched.

As described above, the strain gauge sensors are separately arranged with their arrangement and shapes provided as appropriate, and the strain gauge sensors are basically composed of one layer so as to be easily manufactured. This makes it possible to reduce the number of components, thereby saving space and reducing cost. In addition, an application has a structure in which different strain gauge sensors are attached to both surfaces so as to improve the dynamic range of detectable curvatures. Malfunction of the touch panel can be prevented by combining the touch sensor and the strain gauge sensor. The reduced number of components saves space and reduces the cost. A bent place can be detected by using two types of strain gauge sensors so as to improve the degree of freedom of input schemes.

The system has the following characteristics:

(1) A system enabling both bending input and touch input by using the strain gauge sensors (see the flowchart).

(2) A system that detects and inputs a curvature of bending (power on and off, page turning, enlargement and contraction, and the like) using the strain gauge sensors.

(3) A system that detects the curvature of bending with the strain gauge sensors and locally cancels a signal.

(4) The strain gauges are mounted on the front or rear surface, or both the surfaces of a sheet display.

(5) The strain gauges are basically mounted on the upper left and right portions and the upper center portion of the sheet display (also mounted on the four corners and upper and lower, right and left center portions, depending on functions).

In comparison with the conventional techniques, the embodiment can provide the following advantages:

(1) A reduced number of components saves space and reduces cost.

(2) A bent place can be detected by using two types of strain gauge sensors, which improves the degree of freedom of input schemes.

(3) The embodiment provides a mechanism of preventing malfunction of the touch panel by using results of detection made by the touch sensor and the strain gauge sensor in combination.

Note that the invention is not limited to the above-described embodiments and various modifications can be made in a range without departing from the scope of the invention. For example, other elements than the strain gauge sensors may be used for detecting bending. In addition, a touch sensor other than the capacitive touch sensor may be used.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a display;
a first detector configured to detect displacement of a first area of the display when the display is bent;
a second detector configured to detect displacement of a second area of the display when the display is bent; and
a controller configured to direct performance of a first operation based on the displacement of the first area and the second area.

2. The information processing device of claim 1, further comprising:
a touch sensor, wherein
the controller is configured to direct performance of the first operation based on displacement of a third area on which the touch senor is provided when the displacement of the third area is lower than a first threshold.

3. The information processing device of claim 1, wherein the first area and the second area are adjacent to each other or on a front and a back of the display.

4. The information processing device of claim 1, wherein each of the first detector and the second detector comprises a strain gauge sensor.

5. An input device comprising:
a display;
a first detector configured to detect displacement of a first area of the display when the display is bent; and
a second detector configured to detect displacement of a second area of the display when the display is bent.

6. An information processing method on an information processing device comprising a display, the information processing method comprising:
detecting displacement of a first area of the display when the display is bent;
detecting displacement of a second area of the display when the display is bent; and
directing performance of a first operation based on the displacement of the first area and the second area.
